(19) United States
(12) Patent Application Publication
(10) Pub. No.: US 2023/0264538 A1
(43) Pub. Date: Aug. 24, 2023

(54) HIGH EFFICIENCY HEATING SYSTEM FOR ELECTRIC VEHICLE

(71) Applicants: Richard L. Lewis, Mesa, AZ (US); Damon Kuhn, Houston, TX (US); Charles Maury, Mesa, AZ (US); Sean Loehr, Mesa, AZ (US); James Maury, Mesa, AZ (US)

(72) Inventors: Richard L. Lewis, Mesa, AZ (US); Damon Kuhn, Houston, TX (US); Charles Maury, Mesa, AZ (US); Sean Loehr, Mesa, AZ (US); James Maury, Mesa, AZ (US)

(73) Assignee: zero Electric Vehicles Corp., Gilbert, AZ (US)

(21) Appl. No.: 17/803,122

(22) Filed: Feb. 18, 2022

(51) Int. Cl. B60H 1/22; H05B 3/44

(52) U.S. Cl. CPC B60H 1/2221; H05B 3/44; H05B 2203/032

(57) ABSTRACT

A highly efficient heating system for an electric motor vehicle embodies a heat exchanger for warming passenger compartment air and an electrically powered radiant heating source for heating fluid to be circulated through the heat exchanger. The radiant heating source can be infrared, microwave or other frequency selected to efficiently heat the fluid to be circulated through the heat exchanger.

### FIELD OF THE INVENTION

The subject invention relates to electric vehicles, and specifically to a means for heating (or supplementary heating) of the passenger compartment thereof.

### BACKGROUND OF THE INVENTION

Electric vehicles are making inroads into the fleet far more rapidly than had been anticipated. This trend has been accelerated by concerns about climate change, and a consequent desire to minimize the use of fossil fuels and carbon dioxide production. While it is true that the electrical grid used to charge electric vehicles is often supplied by fossil fuels (though less and less by coal), even the cleanest and greenest of fossil fuel generation techniques inevitably produces carbon dioxide. Still, a small number of stationary fossil fueled generation plants are easier targets for emission control than millions of mobile internal combustion engine vehicles. What began with smaller manufacturers and niche vehicles is rapidly spreading. Even Ford Motor and General motors announced ambitious plans to rapidly pivot to an all electric fleet. Electric vehicle sales grew worldwide by 15 percent in 2019 compared to 2018, with even more significant growth in various regions. For example, pure electric sales grew by over 90 percent in Europe, where fossil fuel emission reductions have been stressed far more than in the US. The UK has suggested a ban on all polluting vehicles (anything burning fossil fuels) by 2035. Recent political and economic trends in the US can be expected to bring similar regulatory pressures to bear in the US. The European tail may well wag the world dog, with China bringing similar pressures.

Electric vehicles are typically roughly divided into the two categories of BEVs, all and only battery driven, and PHEVs, plug in hybrid vehicles, which include a small internal combustion engine to take over when battery capacity runs low. Obviously, pure electrics are preferable from the standpoint of emissions, cost and simplicity, and it is contemplated that they will be essentially 100 percent of the electric vehicle market in the near future.

The trend toward pure electrics has been given further impetus by improvements in charging stations, both home based and commercial, and by improvements in battery technology, in terms of capacity, reliability, operating life, less expensive materials, and weight. Proposed battery improvements fall into several categories. It is proposed to add silicon to the current lithium ion battery to improve charge density. Another proposal is to switch form lithium ion to a lithium iron system, a potentially big change in cost due to the elimination of cobalt, a rare and expensive material. An even bigger change is solid state technology, with lithium electrodes but a solid state ceramic storage medium. A happy synergy would be the use of improved batteries both in vehicles directly, and as excess storage capacity at solar and wind plants to even out the capacity swings, and ease capacity problems on the already stretched grid.

Charging stations increasingly use non-contact, inductive charging, which provides a big increase in consumer convenience, even as compared to gasoline pumping stations. The confluence of improved battery technology and non-contact charging stations is hoped to provide rapid charging in the 15 minute range, as opposed to overnight waits. However, it is unlikely that all of these promised or hoped-for technologies will come together anytime soon. Even present day technology will certainly bring about a large and accelerating growth, however, and bring with it some inherent problems and drawbacks.

Electric vehicles in the near term will be unable to compete with one advantage of fossil fueled vehicles, and that is the massively greater energy density of a tank of a gasoline as compared to a fully charged battery pack. For example, a 15 gallon gas tank can hold up to 500 kilowatt hours of available energy, up to six times the available energy of a typical battery array. Moreover, the inherent inefficiency of the internal combustion process creates ample high temperature waste heat that can be used for cabin heating in the vehicle. With an electric vehicle, there is no such readily available, high quality source of waste heat. Batteries produce some waste heat, but more so in the summer when it isn't useful. It is far more important to keep batteries cool rigorously, even if it means forgoing some waste heat recovery, for safety reasons. As a practical matter, all power for heating will have to be drawn from the batteries, directly or indirectly, with a consequent diminution in vehicle range per trip.

The simplest heating system is copper coil direct conductive heating in seats, floor mats and steering wheels, comparable to that used currently in internal combustion engines for direct and rapid passenger comfort. Those present a direct draw on the battery packs. Such direct heating is typically not sufficient, and only supplements a heated coil or coil with forced cabin air blown directly over it. A recent test of such a vehicle showed a marked decrease in vehicle range, with up to 35% of the available energy being used for cabin heating.

Another fairly common HVAC system uses a heat pump, reversible to provide both cooling in the summer and heating in the winter. In summer, the cooling is provided as with a typical Carnot cycle (refrigerant cycle) air conditioner. The compressor is driven by a battery powered electric motor, not belt driven from an internal combustion drive shaft, and excess cabin heat is dumped to the ambient air through the outdoor heat exchanger serving, in summer mode, as the condenser. In winter, the heat exchangers are switched so that the outdoor exchanger, the one exposed to cold ambient air, becomes the cold evaporator, which, if colder than the still cold evaporator will absorb heat from that less cold ambient air to transfer to ultimately transfer to the cabin. While the electrical energy investment in running the compressor brings an energy bonus from the ambient air, that rate of return obviously decreases just when it's most needed, that is, when the outside or ambient air is at its coldest. Therefore, some kind of directly electrically driven supplemental heating, like conductive seat heating, will typically be required.

An alternative to conventional copper coil direct conductive seat heating has been proposed that would be structurally integrated into the vehicle itself. A technical fabric comprised of interwoven conductive and non-conductive fibers, panels of which would be incorporated into the body, walls, roof seats and mats of the car, enveloping the passenger in a heated envelope. This is described as providing heat directly and quickly to the passengers. In fact, that's inaccurate. Such a system would instead primarily cut down on the amount of heat radiated from the passenger to the otherwise cold vehicle structure. It would reduce the cooling of the passenger, but not heat the passenger directly, with the possible exception of the seat cushion and back panels. As such, the system would provide a supplement at best.

One proposal for heating supplemental to the heat pump is direct radiant or infrared heating of the passengers, essentially as the sun does. Radiant panels or bulbs would be incorporated into the roof panels or headliners to radiate to passengers This works best when heating exposed skin, such as the face, but would obviously be insufficient for overall comfort of the passenger.

As is evident from the drawbacks of these prior systems, a need exists for efficiently and effectively and directly warming the air of the passenger cabin, regardless of any other independently acting systems.

Some history and background of infrared light in general and its use in heating is useful at this point. While working in the early 1800s to measure the temperature of the various colors of light in the visible spectrum, William Herschel discovered an unexpected phenomenon. It was not known at that point that not all light was visible, but a thermometer registered a significant temperature at a point below the lowest visible light. Energy was clearly being transferred somehow. The descriptive name chosen for this heretofore unknown form of radiation was “infrared,” or “lower than red.” This name can be confusing, however, as infrared is higher in wavelength (longer), though lower in frequency, than visible light. Subsequent analysis has established that infrared wavelengths extend from 700 nanometers to 1 millimeter with frequencies from 300 Gigahertz to 430 Terahertz.

While invisible to the eye, infrared light is very detectable by the human body or any other absorptive object or surface and is the primary mechanism of solar heating of the earth. It travels relatively unimpeded from the Sun, through the vacuum of space, in parallel lines. A human unable to see visible light would still very much feel its warmth. In fact, not surprisingly, the human body has evolved to respond favorably to the radiation of infrared light. That is the impetus for its use for direct passenger heating in a car referred to above, though that is not how it is proposed to be used in the subject invention.

Scientists and engineers have developed a common means of infrared heating known as quartz tube heating. Heating coils within a protective and surrounding quartz tube are energized to produce infrared heat at the desired wavelength. The quartz tub passes the rays with little effect, which then impinge on whatever object is in the path. Often, the outside of the tube facing away from the object to be heated is coated with a reflective layer, such as thin gold, to reflect heat all in the direction desired.

U.S. Pat. No. 6,868,230 discloses a different type of infrared heating assembly, a variation of the typical quartz tube infrared heater. It does not disclose or discuss its use for the desired use of the subject invention, however. As described in the published patent—

“The heater assembly includes an inner member (heating element), for example, a quartz glass tube, where at least a portion of a major surface has a conductive coating disposed thereon. Electrical connection to the conductive coating can be made by at least two connection means (connections) that are disposed onto and are in electrical contact with the conductive coating. The connection means are disposed in such a manner as to define a set of parallel heating sections that provide the desired heating elements for the heater assembly. Consequently, an external power source is electrically connected to the connection means.

At least two end caps, each with a major inner member void defined within, are disposed on separate end portions of an outer member, for example, a quartz glass tube. The inner member is positioned within the outer member and mechanically attached to and extending through the end caps' major voids. In addition, the end caps have minor voids defined within that provide wire pathways, and vacuum drawing and sealing means for drawing and sealing a vacuum within the space defined between the outer and inner elements.

With the inner member having an axial void defined therethrough, the heater assembly would be used to heat material, for example, fluids, as they would flow through the axial void of the inner quartz glass tube. If the major surface of the inner member is not completely coated, then the heater assembly can be used to heat objects.”

While the description above does not make in perfectly clear, the patent discloses that the quartz tube, rather than just being clear, is empty on the inside (no coil on the inside, as is typical), and provided on the outside surface with a conductive coating of a doped metal (tin) oxide, such as a fluorine doped tin oxide. This can be applied by spinning the tube and applying a chemical spray, or by chemical vapor deposition (CVD) or spray pyrolysis. Connectors, such as conductive wire mesh or conductive metal bus bars are conductively attached to the outer conductive coating. Connectors can be applied so as to define one large heating path with the outer conductive layer or so as to provide a series of smaller area, parallel heating paths.

The basic quartz glass tube is itself run coaxially in end sealed fashion through an outermost, additional quartz tube, which does not affect the operation of the inner tube, but merely provides additional insulation and protection. Heat that is generated by the coating radiates into the interior of the axial passage, but radiates very little heat directly radially outwardly, as the conductive coating acts as a radiation barrier. It is claimed that a fluid would be heated flowing through the central passage. However, no particular fluid is disclosed, nor is there any disclosure of how the infrared heat would be transferred thereto. Nor is any means disclosed for extracting and using that heat in a vehicle or elsewhere.

### SUMMARY OF THE INVENTION

A preferred embodiment of the subject invention makes use of a radiant (preferably infrared) heater assembly with an axially extending passage and an axially coextensive radiant heating means and associated connectors. The heater assembly has a radiant energy absorptive fluid pumped through a central passage by a temperature controlled pump. Heated fluid is directed to a fluid-to-air heat exchanger, assisted by a fan, if needed. This puts heated air into the passenger cabin as either a stand-alone heat source, or as a supplement to a main heat source in the vehicle. The radiated energy may be infrared or other portion of the spectrum, such as microwave, provided that the radiant energy absorptive fluid is selected to efficiently absorb the radiated energy.

### DESCRIPTION OF THE DRAWING

FIG. 1 illustrates four components useful in the implementation of the invention.

### DETAILED DESCRIPTION OF THE PREFERRED EMBODIMENTS OF THE INVENTION

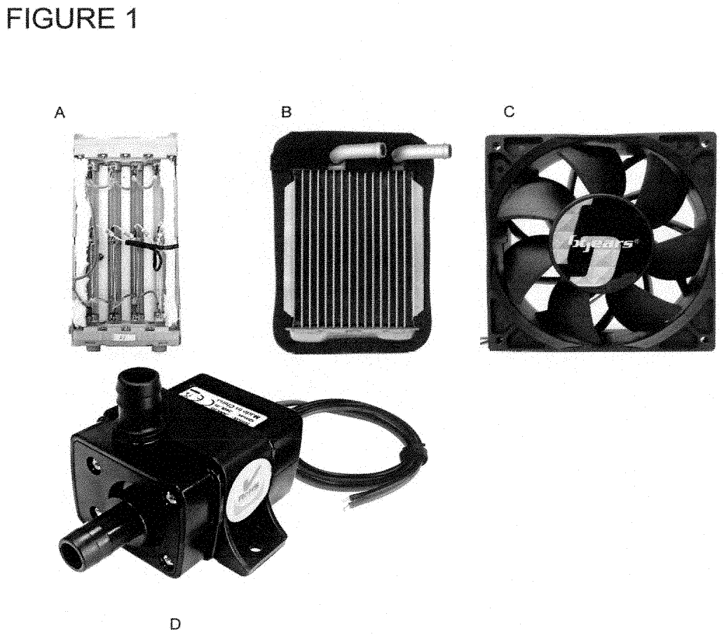

The invention is described by reference to FIG. 1 that illustrates components A through D that are useful in the implementation of the invention.

The infrared heater assembly A includes, most basically, an outer infrared tub type heater that defines a central, axially extending fluid flow passage. This may be an outer quartz tube with a conductive outer surface coating and associated electrodes which, when energized, produces infrared radiation at the desired wave length. Because of the conductive coating's location and orientation, that radiation is directed radially inwardly toward the empty centrally axially extending flow passage. If the outer conductive coating on the outer tube is not sufficiently reflective, an over coating could be provided, as by very thin gold. Gold is useful because of its oxidation resistance and very high infrared reflectivity of approximately 95%. If desired, an insulative and protective outer tube or other layer could be put over the outer surface the central tube for thermal and mechanical protection, which would not affect its basic operation.

Alternatively, the assembly A could consist of an outer tube with no outer conductive coating, but with a reflective inner surface, and with a more or less conventional inner quartz heater tube running centrally and coaxially through it. This inner tube would contain heated coils and connectors to produce infrared radiative energy, but with no conductive or reflective coatings on either its inner or outer surface. It would be essentially like a commercially available quartz heater tube. The reflective inner surface on the inner surface of the outer tube could be provided by an additional inner tube layer of gold or the like, either directly or inserted separately as an additional tube or film, thereby avoiding a spraying or sputtering or dipping procedure. A close fitting extra inserted tube of other durable material coated on its inner surface could also serve to provide the radially inwardly facing reflector layer. An axially extending axial passage of annular cross section would thereby be defined between the conventional inner quartz heater tube and the reflective inner surface of the outer non-heated quartz tube. Suitable connectors could extend radially outwardly from the radially inner tube and out through, or otherwise outside of, the outer tube without significant blockage of the defined annular space. Quartz could be chosen for the outer tube, in this embodiment, for its durability and heat resistance, though other materials could serve. In this embodiment, radiant infrared energy would be radially outwardly directed from the heated coil inside the inner quartz heater tube, through its clear inner quartz tube and to the reflective inner surface of the outer tube, and then radially back, continuously through the annular space. This presents some obvious advantages, as the inner quartz tube could be conventional, and the outer surrounding quartz (or other suitable material) tube could. be easily and inexpensively produced. Both embodiments provide an axially extending central fluid flow passage that has an axially coextending (at least partially coextending) heating means to heat fluid pumped therethrough.

Either embodiment described above would have a suitable liquid heat transfer medium pumped through the central flow passage space by a pump D. This could be relatively small power, similar to an aquarium pump or the kinds of small pumps used for liquid computer cooling systems. Pump D would incorporate flow control valves in addition to its basic on-off controls. Ideally, the heat transfer fluid would be made infrared absorptive, either by dark coloration or by a contained suspension of radiant heat absorptive small granules or flakes. Flow into and out of the heater assembly A would be provided by tubing sealed to the ends of the central passage. In the alternative embodiment described, such tubing might have to be provided with a means for routing electrical wiring therethrough for the inner heater. This would not be necessary for the first embodiment, where the wiring is entirely outside the flow passage.

To extract useful cabin heating heat from the fluid so heated, a liquid to air heat exchanger B would be used. This could be relatively small, or as large as a typical vehicle heater core (another standard component) depending on need. In the absence of sufficient natural convective flow, a powered fan could be provided. This could also be a standard component, such as a computer air cooling fan or automotive heater fan.

In operation, temperature sensors and controls would be provided in a system to sense cabin temperature and heater assembly temperature, and send heated fluid through the assembly of heat exchanger B and fan C as needed. The heat exchanger B could also be fed by waste heat from any other available source in the vehicle, such as battery packs or traction motors, or a main heat pump system.

In an alternative embodiment of the invention, the radiant energy is microwave energy and the fluid within the system is water, with suitable antifreeze. This has a desirable characteristic in that water is readily available and is quite efficiently heated by radiated microwave energy. Microwave heaters are readily available and could easily be substituted for the infrared heater structure described with respect to the foregoing embodiment of the invention. A commercially important consideration in selection of the heating source is the energy efficiency of the transmission of energy into the carrier fluid. As has become well known, microwave energy is readily converted to heat in water. By directing microwave energy into water, the heating process is quite efficient. The heating chamber could enclose a microwave radiator outside of a segment of quartz tube that runs through the microwave chamber. Microwave chokes could be placed around the periphery of the quartz tube at its entry and exit locations into/from the microwave chamber to prevent microwave leakage. The system could be substantially the same as described above with respect to the infrared heating arrangement.

Variations of the disclosed embodiments within the spirit of the invention can be made. The heater assembly A can be scaled up or down, both in size, and in number of tube units, which could easily be ganged together and plumbed in parallel. Any new or improved pump, radiator or fan, or multiples thereof, could be incorporated with no change to the basic operation of heater assembly A. This would provide greater of lesser fluid and air flow rates as needed. The control system could be custom designed to allow variable control of all components, pump fan and heater, as desired.

1. A heating system comprising,
a heater assembly including a central axially extending fluid flow passage into which infrared heat is radially directed by an axially coextending infrared heating means,
an infrared absorptive fluid supply, and,
a pumping means for directing said absorptive fluid through the central flow passage.

2. A heating system as described in claim 1, in which the central flow passage is formed by an outer tube provided on its outer surface with an electrically conductive layer which, when energized, directs infrared radiation radially inwardly to the flow passage.

3. A heating system as described in claim 2, in which the central flow passage is provided by an outer tube and the heating means is provided by a coaxial inner infrared tube heater forming a central passage of annular cross section within said outer tube through which heat is radially outwardly directed.

4. A heating system as described in claim 3, in which the inner surface of said outer tube is provided with a reflective layer.

5. A heating system as described in claim 1, further comprising a fluid to air heat exchanger through which heated fluid is pumped.

6. A heating system according to claim 5, further comprising a fan to force air through said heat exchanger.

7. A heating system for the interior of an electric vehicle comprising a carrier fluid, a fluid distribution structure comprising a heat absorption section and a heat radiation section, a radiant energy source located proximate said heat absorption section and an air distribution system in thermal communication with said heat radiation section.

8. A heating system as claimed in claim 7 wherein said source of radiant energy produces at least one of microwave or infrared energy.

9. A heating system as claimed in claim 7 wherein said source of radiant energy produces microwave energy,

10. A heating system comprising,
a heater assembly including a central axially extending outer tube and a coaxial, inner infrared tube heater within said outer tube forming a central passage of annular cross section through which heat is radially outwardly directed from said heater.
an infrared absorptive fluid supply, and,
a pumping means for directing said absorptive fluid through the central flow passage.

11. A heater assembly according to claim 10 in which said outer tube includes an inner reflective layer facing said heater.

12. A heater assembly according to claim 10 in which said outer tube contains a close fitting inner reflective layer that is separately inserted therein.

13. A heating system according to claim 10, in which said heater assembly is a quartz tube heater producing infrared heat.

14. A heating assembly according to claim 10 in which said heater assembly is a source of microwave energy.

15. A heating system comprising,
a heater assembly including a central axially extending fluid flow passage formed within an outer tube provided on its outer surface with an electrically conductive layer which, when energized, directs infrared radiation radially inwardly into which infrared heat is radially directed inwardly.

16. A heater assembly according to claim 15, further comprising,
an infrared absorptive fluid supply, and,
a pumping means for directing said absorptive fluid through the central flow passage.

17. A heater assembly according to claim 16, further comprising a suspension of heat absorptive granules in said fluid supply.

18. A heater assembly according to claim 17, further comprising,
a fluid to air heat exchanger through which heated fluid is pumped, and,
a fan to force air through said heat exchanger.
